(19) United States
(12) Patent Application Publication
(10) Pub. No.: US 2018/0314322 A1
(43) Pub. Date: Nov. 1, 2018

(54) SYSTEM AND METHOD FOR IMMERSIVE CAVE APPLICATION

(71) Applicant: Motive Force Technology Limited, Hong Kong (HK)

(72) Inventor: Chun Hung Tseng, Hong Kong (HK)

(21) Appl. No.: 15/955,762

(22) Filed: Apr. 18, 2018

Related U.S. Application Data
(60) Provisional application No. 62/491,278, filed on Apr. 28, 2017.

(51) Int. Cl. G06F 3/01; G06T 7/215; G06T 19/00; G06T 7/73

(52) U.S. Cl. CPC G06F 3/011; G06T 7/215; G06T 19/003; G06T 7/73; G06T 19/006

(57) ABSTRACT

The present disclosure relates to a system for implementing an immersive Cave Automatic Virtual Environment (CAVE), wherein the proposed system includes a master server engine that is configured to enable multi-side electronic visual displays, and further includes a real-time motion tracking engine that is operatively coupled with the master server engine. The motion tracking engine can be configured to, in real-time, determine cyber-physical position data of at least one motion tracked object across X, Y, and Z coordinates using one or more motion track sensors that are operatively coupled to said real-time motion tracking engine, and enable generation of tracking data of said at least one tracked object based on said cyber-physical position data, said tracking data being used to integrate and visualize said at least one tracked object in said CAVE.

### PRIORITY CLAIM

This application claims the benefit of priority to U.S. Provisional Patent Application No. 62/491,278 filed Apr. 28, 2017, the contents of which are incorporated herein by reference in their entireties. Where a definition or use of a term in a reference that is incorporated by reference is inconsistent or contrary to the definition of that term provided herein, the definition of that term provided herein is deemed to be controlling.

### FIELD OF THE INVENTION

The present disclosure relates to a system and method for implementation of virtual reality (VR) and/or mixed reality (MR) environment, and more particularly relates to an immersive CAVE (Cave Automatic Virtual Environment) implementation/architecture.

### BACKGROUND

The following description includes information that may be useful in understanding the present invention. It is not an admission that any of the information provided herein is prior art or relevant to the presently claimed invention, or that any publication specifically or implicitly referenced is prior art.

Immersion into virtual reality is a perception of being physically present in a non-physical world. The perception is created by surrounding user of the VR system in images, sound or other stimuli that provide an engrossing total environment. Immersive virtual reality includes immersion in an artificial, computer generated environment where the user feels just as immersed as they usually feel in consensus reality.

Immersive virtual reality can be divided into two forms: individual and shared. The individual VR market has expanded fiercely over the last few years due to rapid development of devices like head-mounted displays. As individual VR equipment is designed for personal experience, it is unlikely to have proven success of individual VR gear application in enterprise use. Cave automatic virtual environment (usually known as “CAVE”) is a form of immersive VR for multi-users. A lifelike simulated visual is created by projectors (or other visual equipment supports 3D stereo) and controlled by physical movements from a user inside the CAVE. A motion capturing system records real-time position of user or motion tracked objects. Stereoscopic LCD shutter glasses convey a 3D image. The computers rapidly generate a pair of images, one for each of the user's eyes, based on motion capture data. The glasses are synchronised with the projectors so that each eye only sees the correct image. Usually one or more servers drive the projectors.

The CAVE is a room-sized cube (typically 10×10×10 feet) consisting of three walls and a floor. These four surfaces serve as projection screens for computer generated stereo images. The projectors are located outside the CAVE and project the computer generated views of the virtual environment for the left and the right eye in a rapid, alternating sequence. The user (trainee) entering the CAVE wears lightweight DLP shutter glasses that block the right and left eye in synchrony with the projection sequence, thereby ensuring that the left eye only sees the image generated for the left eye and the right eye only sees the image generated for the right eye. The human brain processes the binocular disparity (difference between left eye and right eye view) and creates the perception of stereoscopic vision. A motion tracker attached to the user's shutter glasses continuously measures the position and orientation (six degrees of freedom) of the user's head. These measurements are used by the viewing software for the correct, real-time calculation of the stereo images projected on the four surfaces. A hand-held wand device with buttons, joystick, and an attached second motion tracker allows for control of and navigation through the virtual environment.

Immersive CAVE for shared users is suitable for enterprise applications as it allows multiple users to immerse themselves in and interact with the same lifelike simulated environment with natural communication by talking to and seeing each other without blinding eyes. It enhances communication process and productivity, and reduces process redundancies with its interactive simulation. A broad range of applications can be catered, including but not limited to: AEC (architecture, engineering, construction), real estate, technical training, automotive, medical, product development, behavioral analysis, rehabilitation, education, exhibition, tourism, sports training, edutainment and anything that can be reviewed or evaluated in the computer-generated environment.

Despite its endless possibility, immersive CAVE is a comparatively niche market. It is not commonly found in mass market for some reasons. Generally, immersive CAVE includes am engine, motion capture system with associated SDK, servers to drive projectors, game engine to support real-time interaction with 3D (3-Dimensional) scene, and 3D application tool to convert 3D simulated content into physical visualization in multi-dimensional environment. The above-mentioned components are usually provided by different developers and each of them comes with certain technologies and specifications. Therefore, many immersive CAVE VR solution or product providers focus on system integration, which has resulted in difficulty of maintenance, high software license and/or hardware cost of each component. Besides, it requires a broad range of in-depth technological knowledge and experience to integrate an immersive CAVE system, including 3D application tools, full body motion capture technology, virtual and physical perspective mathematical calculation, 3D stereo, electronic engineering, mechanical engineering, digital output technology, which makes integration of an immersive CAVE a niche and difficult job as solution providers have to overcome technological issues of every single component, and to permeate all elements into a smooth operating system. It takes either a group of professional to get involved in each project or expertise specialised in immersive CAVE, who is rarely seen in the market. All of the above technical problems resulted in a high cost product with limited or expensive technical support.

Apart from that, because integrated 3D application tools are designed for professional use, only professional users with hand-on 3D applications technique can create virtual content for immersive CAVE. Or, even worse, non-professional users may have to rely on the immersive CAVE provider or its authorized vendors to assist on content creation. This narrows down the possible usage of immersive CAVE in mid to low commercial market with its high sustaining cost and comparatively long production time. Usually, only billionaire enterprises such as vehicle manufacturer, medical, utility, military group or institution with generous funding can afford immersive CAVE.

In the evolution of fourth industrial revolution, there is a need for cyber-physical systems that can reduce actual physical work, resources, and losses. Much traditional process can be replaced, done or practiced through the use of AR and/or VR technology. Technology of multi-user full body immersive CAVE can be popularized and utilized in the era of industry if it is more affordable to most SMEs and/or educational organizations.

Therefore, there is a need of an enhanced immersive CAVE system that simplifies integration of components, allows both professionals and/or end-users without programming or 3D application background to create immersive simulated content.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY

The present disclosure relates to a system and method for implementation of virtual reality (VR) and/or mixed reality (MR) environment, and more particularly relates to an immersive CAVE (Cave Automatic Virtual Environment) implementation/architecture.

In an aspect, the present disclosure relates to a system for implementing an immersive Cave Automatic Virtual Environment (CAVE), wherein the system includes a master server engine that is configured to enable multi-side electronic visual displays, and further includes a real-time motion tracking engine. In an aspect, the real-time motion tracking engine can, using the master server engine, in real-time: determines cyber-physical position data of at least one motion tracked object across X, Y, and Z coordinates using one or more motion track sensors that are operatively coupled to the real-time motion tracking engine; and enable generation of tracking data of the at least one tracked object based on the cyber-physical position data, wherein the tracking data is used to, by the master server engine, integrate and visualize at least one tracked object in the CAVE.

In an aspect, the proposed system further comprises an import module that enables a user to import digital visual content into the master server engine for real-time immersive content visualization. In another aspect, the digital visual content can be created by any or a combination of a 3-dimensional (3D) application, a 2-dimensional (2D) application, or a visual recording/scanning technology.

In an aspect, the master server engine can be configured to perform real-time computation of 360 full aspect perspective. In another aspect, the multi-side electronic visual can be configured to display range from 1 to 6 side displays. In yet another aspect, the at least one motion tracked object can be a user of the proposed system. In another aspect, the at least one tracked object can be projected onto a tangible medium using Digital Light Processing (DLP) 3D glasses.

In an aspect, the at least one tracked object can be visualized in any or a combination of a cube-shaped environment, an immersive VR environment, a head-mounted display enabled environment, desktop computer enabled environment, display screen enabled environment.

In another aspect, the at least one motion tracked object can be attached to a user such that when the user is in a motion tracking area, the motion tracking engine, using the one or more motion track sensors, detects viewpoint and position of the at least one motion tracked object so as to generate the cyber-physical position data.

In another aspect, the at least one motion tracked object can be operatively coupled with or include at least 3 motion track markers such that position of each motion track marker can be defined by its X-axis, Y-axis, and Z-axis, wherein X-axis represents horizontal position in relation to front and behind of motion tracking area, wherein Y-axis represents horizontal position in relation to left and right side of the motion tracking area, and wherein Z-axis vertical position in relation to top side of the motion tracking area. In an aspect, the one or more motion track sensors can be selected from any or a combination of optical motion track sensors, and sensors configured to enable motion tracking across 3 degrees of freedom (DOF), 6 DOF, 9 DOF, infrared, OpenNI. In another aspect, the one or more motion track sensors can detect infrared light to communicate position and rotation data of the at least one tracked object to the master server engine.

In an aspect, the at least one tracked object can be controlled for any or a combination of navigation, change in viewing point, and interaction with other visualized objects through a controller. The at least one tracked object can also, in an aspect, be visualized in a 6-side simulated environment by receiving, at one or more projectors, the tracking data from the master server engine, and blending and wrapping the received tracking data to generate a full aspect view of the at least one motion tracked object in the simulated environment. In an aspect, the tracking data can be transformed into at least one virtual object in virtual scene at the time the blending/wrapping operations are being performed (or are to be performed). In an aspect, tracking data can also referred to as real-time rendered visuals/images in context of the blending and wrapping operations.

In an aspect, the tracking data can include virtual positions and angles of the at least one tracked object.

The present disclosure further relates to a method for implementing an immersive Cave Automatic Virtual Environment (CAVE), the method comprising the steps of: determining, by real-time motion tracking engine that is operatively coupled with a master server engine, cyber-physical position data of at least one motion tracked object across X, Y, and Z coordinates using one or more motion track sensors that are operatively coupled to the real-time motion tracking engine; and enabling, by the master server engine, generation of tracking data of the at least one tracked object based on the cyber-physical position data, the tracking data being used to integrate and visualize the at least one tracked object in the CAVE, wherein the master server engine is configured to enable multi-side electronic visual displays.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

FIGS. 1A and 1B illustrate schematic drawings of a system that provides full body immersive VR and MR simulated environment in accordance with an embodiment of the present disclosure.

FIGS. 2A to 2C illustrate exemplary flow diagrams that show process of implementation of physical interaction with VR and MR simulated environment in accordance with embodiments of the present disclosure.

FIG. 3A illustrates an exemplary motion tracking area to be covered by motion track sensors in a 3-dimensional view in accordance with an embodiment of the present disclosure.

FIG. 3B illustrates motion tracking area to be covered by motion track sensors from top view.

FIG. 4 illustrates examples of different combinations of motion track target on active 3D glasses for user's perspective tracking in accordance with an embodiment of the present disclosure.

FIG. 5A illustrates examples of possible combinations of motion track target on different forms of physical objects, as well as corresponding presence forms in virtual world in accordance with an embodiment of the present disclosure.

FIG. 5B illustrates examples of how motion track target is attached on various physical objects in accordance with an embodiment of the present disclosure.

FIG. 6A illustrates a representation where user's perspective is defined by motion track target and is tracked within motion tracking area in accordance with an embodiment of the present disclosure.

FIG. 6B illustrates a representation showing calculated viewpoint of motion tracked target perspective in virtual world in accordance with an embodiment of the present disclosure.

FIG. 6C illustrates physical rotation of user's perspective in accordance with an embodiment of the present disclosure.

FIG. 7A illustrates correlation of perspective angles in real world and virtual world from side view in accordance with an embodiment of the present disclosure.

FIG. 7B illustrates correlation of perspective angles in real world and virtual world from top view in accordance with an embodiment of the present disclosure.

FIG. 8A illustrates an exemplary representation showing how physical object is defined by motion track target, and is tracked within motion tracking area in accordance with an embodiment of the present disclosure.

FIG. 8B illustrates motion tracked physical object's presence in the physical world in accordance with an embodiment of the present disclosure.

FIG. 8C illustrates motion tracked physical object's corresponding location in virtual world in accordance with an embodiment of the present disclosure.

FIG. 9 illustrates rotation of physical object in accordance with an embodiment of the present disclosure.

FIG. 10 illustrates exemplary interaction of motion tracked physical object and simulated environment in augmented reality in accordance with an embodiment of the present disclosure.

FIG. 11 illustrates real-time calculated perspective in full aspect in accordance with an embodiment of the present disclosure.

FIG. 12 illustrates calculation of perpendicular display format of the subject technology in accordance with an embodiment of the present disclosure.

FIG. 13 illustrates exemplary presentations of full aspect simulated environment in perpendicular display format in accordance with an embodiment of the present disclosure.

FIG. 14 illustrates a diagram of hardware configuration and their connections of embodiments of the subject technology.

FIG. 15 is an exemplary representation illustrating input and output processing of server engine in accordance with an embodiment of the present disclosure.

FIG. 16 illustrates an exemplary representation showing output capacity of the embodied system in accordance with an embodiment of the present disclosure.

### DETAILED DESCRIPTION

The present disclosure relates to a system and method for implementation of virtual reality (VR) and/or mixed reality (MR) environment, and more particularly relates to an immersive CAVE (Cave Automatic Virtual Environment) implementation/architecture.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

In an aspect, the present disclosure relates to a system for implementing an immersive Cave Automatic Virtual Environment (CAVE), wherein the system includes a master server engine that is configured to enable multi-side electronic visual displays, and further includes a real-time motion tracking engine. In an aspect, the real-time motion tracking engine can, using the master server engine, in real-time: determines cyber-physical position data of at least one motion tracked object across X, Y, and Z coordinates using one or more motion track sensors that are operatively coupled to the real-time motion tracking engine; and enable generation of tracking data of the at least one tracked object based on the cyber-physical position data, wherein the tracking data is used to, by the master server engine, integrate and visualize the at least one tracked object in the CAVE.

In an aspect, the proposed system further comprises an import module that enables a user to import digital visual content into the master server engine for real-time immersive content visualization. In another aspect, the digital visual content can be created by any or a combination of a 3-dimensional (3D) application, a 2-dimensional (2D) application, or a visual recording/scanning technology.

In an aspect, the master server engine can be configured to perform real-time computation of 360 full aspect perspective. In another aspect, the multi-side electronic visual can be configured to display range from 1 to 6 side displays. In yet another aspect, the at least one motion tracked object can be a user of the proposed system. In another aspect, the at least one tracked object can be projected (by projector) onto a tangible medium using Digital Light Processing (DLP) 3D glasses. In an aspect, DLP 3D glasses can be used for synchronizing 120 Hz frequency of DLP projector. Apart from projector and DLP 3D glasses, the tracked objected can be displayed on any visual equipment such as LED, LCD panels, desktop monitor etc.

In an aspect, the at least one tracked object can be visualized in any or a combination of a cube-shaped environment, an immersive VR environment, a head-mounted display enabled environment, desktop computer enabled environment, display screen enabled environment.

In another aspect, the at least one motion tracked object can be attached to a user such that when the user is in a motion tracking area, the motion tracking engine, using the one or more motion track sensors, detects viewpoint and position of the at least one motion tracked object so as to generate the cyber-physical position data.

In another aspect, the at least one motion tracked object can be operatively coupled with or include at least 3 motion track markers such that position of each motion track marker can be defined by its X-axis, Y-axis, and Z-axis, wherein X-axis represents horizontal position in relation to front of motion tracking area, wherein Y-axis represents horizontal position in relation to left and right side of the motion tracking area, and wherein Z-axis vertical position in relation to top side of the motion tracking area. In an aspect, the one or more motion track sensors can be selected from any or a combination of optical motion track sensors, or sensors configured to enable motion tracking across 3 degrees of freedom (DOF), 6 DOF, 9 DOF, infrared, OpenNI. In another aspect, the one or more motion track sensors can detect infrared light to communicate position and rotation data of the at least one tracked object to the master server engine.

In an aspect, the at least one tracked object can be controlled for any or a combination of navigation, change in viewing point, and interaction with other visualized objects through a controller. The at least one tracked object can also, in an aspect, be visualized in a 6-side simulated environment by receiving, at one or more projectors, the tracking data from the master server engine, and blending and wrapping the received tracking data to generate a full aspect view of the at least one motion tracked object in the simulated environment.

In an aspect, the tracking data can include virtual positions and angles of the at least one tracked object.

The present disclosure further relates to a method for implementing an immersive Cave Automatic Virtual Environment (CAVE), the method comprising the steps of: determining, by real-time motion tracking engine that is operatively coupled with a master server engine, cyber-physical position data of at least one motion tracked object across X, Y, and Z coordinates using one or more motion track sensors that are operatively coupled to the real-time motion tracking engine; and enabling, by the master server engine, generation of tracking data of the at least one tracked object based on the cyber-physical position data, the tracking data being used to integrate and visualize the at least one tracked object in the CAVE, wherein the master server engine is configured to enable multi-side electronic visual displays.

In an aspect, other hardware elements of the CAVE that can include a sound system, motion tracking system, high-end graphics computer that calculates motion tracked X, Y, Z position and physical-virtual simulation, can be configured to generate stereo images in real-time and execute all calculations and control functions required by various embodiments of the present invention during immersive viewing. In the following description, such a computer can be interchangeably referred to as CAVE computer.

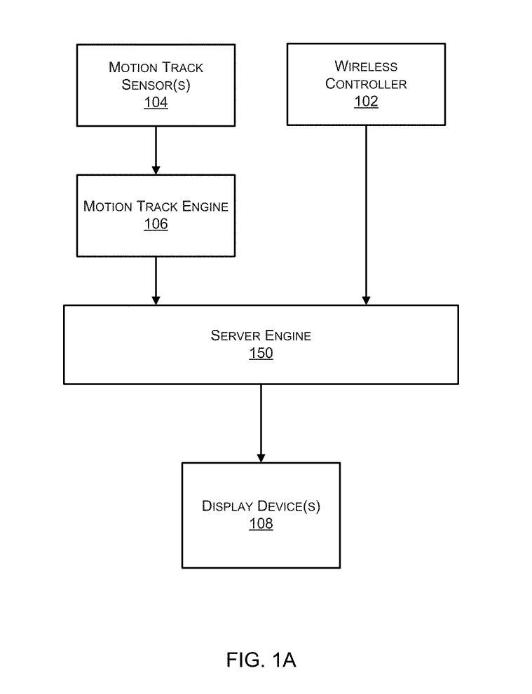

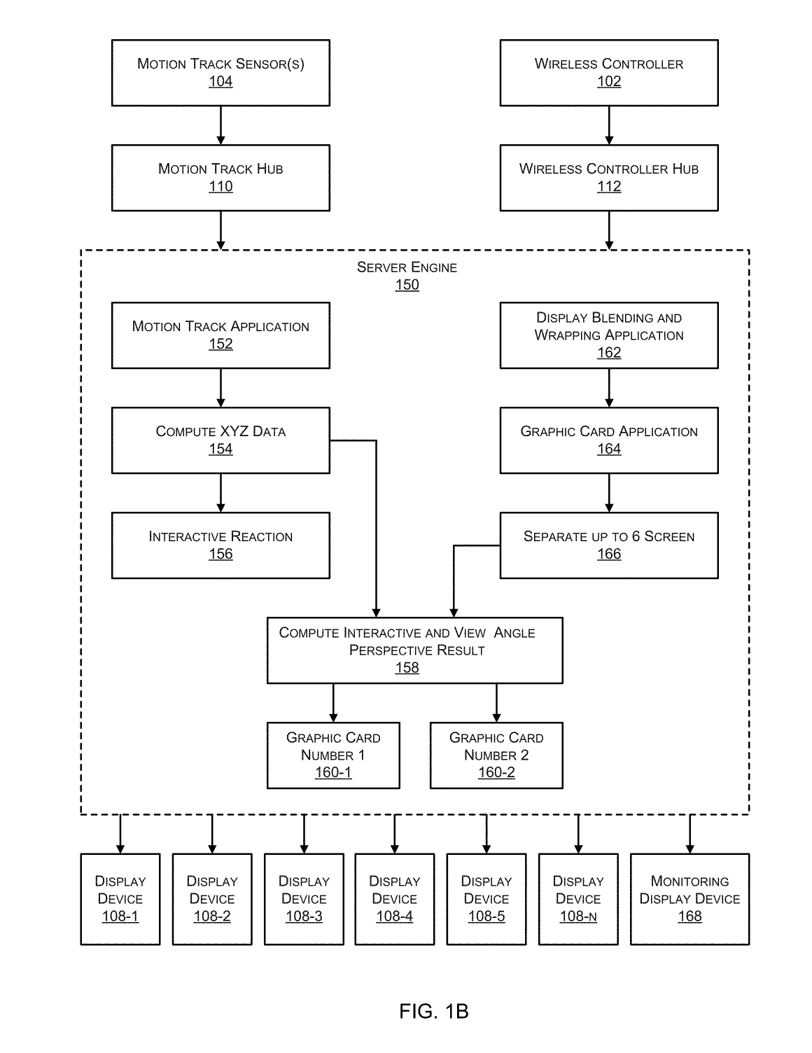

With reference to FIGS. 1A and 1B, in an aspect, the present disclosure relates to a system and method of immersive CAVE implementation/architecture that is embodied on a master server engine 150 that is designed and configured to tackle and overcome above-mentioned disadvantages in the Background section. In an exemplary aspect, the proposed system can include a motion tracking engine 106 (also interchangeably referred to as “motion track engine 106”, which can be a connecting “hub” 110 (third party hardware) or a third-party software 152 for optical motion tracking devices, and a master server engine 150, wherein the server engine 150 can be embodied with cyber-physical position definition, real-time immersive visualization calculation, and (output of) multi-side electronic visual displays. FIGS. 1A and 1B also illustrate schematic representation of the proposed system that is integrated with electronic components and software applications that enable full body immersive VR and MR simulated environment. An example of the proposed embodiment can provide a maximum of 6-side immersive CAVE, including a server engine 150, a plurality of motion track sensors 104, wherein the plurality of motion track sensors 104 can be configured to detect infrared (IR) light and communicate position and rotation data to the server engine 150 through connection of motion track hub 110 of FIG. 1B; a controller 102 that can be configured to input command to the server engine 150 through a wireless control hub 112 with connection to the server engine 150. Motion tracked data 154 can be defined by an embodied motion track application 152 according to principles of X-axis, Y-axis & Z-axis, wherein the proposed server engine 150 can process the X, Y, Z data to calculate simultaneous perspective, object position and interaction 156 with virtual world. Such processed data and calculation can result in real-time 3D stereo visuals that cover the 6-side simulated environment. The 6-side simulated environment distribution can be driven by a built-in display blending and wrapping application 162, which enables formation of a blended, full aspect view. Such a view can be pushed to graphic cards such as 160-1 and 160-2 with embodied application driver 164 to output refreshing images of 6-screen at 120 Hz speed, plus additional one or more monitoring displays such as 168. Display devices such as 108-1, 108-2, . . . , 108-N (collectively referred to as display devices 108 hereinafter), through projectors, can directly receive output data from the server engine 150, and visualize the data at synchronized refreshing speed. When the proposed software embodied system works with non-active 3D visual equipment, such as HMD, it will appear in side-by-side 3D mode.

As mentioned above, the proposed system of the present invention can include a master server engine 150 that can be configured to enable multi-side electronic visual displays 108, and can further includes a real-time motion tracking engine 106 (which can be independent of or coupled to or configured in server engine 150). In an aspect, the real-time motion tracking engine (also interchangeably referred to as motion track engine 106) can, using the master server engine 150, in real-time: determine cyber-physical position data of at least one motion tracked object across X, Y, and Z coordinates using one or more motion track sensors 104 that can be operatively coupled to the real-time motion tracking engine 106; and enable generation of tracking data 158 of the at least one tracked object based on the cyber-physical position data, wherein the tracking data 158 can be used to, by the master server engine 150, integrate and visualize the at least one tracked object in the CAVE.

In an aspect, the present disclosure is aimed at improving functionality of master server engine 150 by enhancing computer architecture with embodied cyber-physical position definition and real-time immersive visualization calculation to replace third party's game engine, 3D application tool, and to save use of sub-server for driving electronic visual displays. As there are less electronic and cyber components to be integrated in the proposed computer architecture, numbers of connection point in-between electronic components are less, and at least the cabling from master engine to sub-server is eliminated. Possibility of delay or error of data transmission in-between components is reduced as well, as a result of which the proposed system is speeded up and rendered more stable with improved coordination of computer architecture.

In an aspect, the present disclosure improves user-friendliness of immersive CAVE. The proposed system allows users to import to master server engine 150 with digital visual content created by 3D applications, and/or by emerging 2D, and/or by 3D visual recording/scanning technologies (e.g., panoramic video, drone shooting, 3D scanning, photometric etc.) and produced for layman without 3D application or programming knowledge. As a result of the proposed system, professional users can stick to industrial and professional applications such as medical and engineering, while non-professional users, which are majority in population, can create immersive content (including, but not limited to, 360 and 3D content) in another way with short learning curve. Skipping of niche 3D applications interactive programming can largely increase the number of content creator/users of immersive CAVE, and also reduce time and cost of creating new content and usage, making the immersive CAVE a sustainable system for various applications.

In an aspect, the proposed system is able to create and display computer generated environment in 360 degrees full space, wherein one or more users can immerse into and interact with the simulated environment and/or scenario. At least a part of the proposed system can be embodied in the master server engine 150 so as to perform real-time calculation of 360 degrees full aspect perspective, in which case, the system can provide 1-6 sides wrapped displays in CAVE environment at lower cost.

In an aspect, the present disclosure can be applied in an embodiment of compact and user-friendly immersive CAVE products, for example, 1-side, 2-side, 3-side and 4-side immersive VR and MR tools. In terms of Mixed Reality (MR), the proposed system can include any physical presence with simulated environment, extend physical objects to the virtual world so that we can manipulate physical objects in both real world and virtual world.

In an aspect, the present disclosure relates to an immersive CAVE system and method that is embodied in 1-side, 2-side, 3-side and 4-side immersive environment. The proposed system further supports real-time motion tracking of multiple sensors, objects, and up to 6-side displays (application 166 can link the server engine 150 with the displays 108). Aspects of the present invention also provide full body immersive VR and MR experience as the simulated environment is projected/displayed on surrounding walls, ceiling and floor of a cube-shaped room (exemplary embodiment and any other VR environment can be created). The simulated environment can provide users with a full aspect of VR that allow users to immerse themselves in. In an aspect, the proposed cyber-physical interaction can be accordance with integration of motion tracking system and application of real-time position and perspective calculation and 3D pairing images generation. Other than physical cube-shaped environment, the proposed system can also support immersive VR with head-mounted device (HMD), desktop computer, LED panel or any screen that can be connected to the server engine 150. In other words, display format of the present disclosure includes, but is not limited to, to the above mentioned visual equipment(s), and can also be considered/implemented as a cross platform system.

In another aspect, when a user is associated/attached with an optical motion track target (an exemplary type of track target) and moves to the motion tracking area, his/her viewpoint and position (or of any other physical object that is attached/coupled with the motion track target) can be detected by motion track sensors 104. Each optical motion track target can be formed by at least 3 motion track markers, wherein position of each motion track marker can be defined by its X-axis (horizontal position in relation to front side of motion track area), Y-axis (horizontal position in relation to left & right side of motion track area) and Z-axis (vertical position in relation to top side of motion track area) by the motion track sensors 104. In an aspect, through the motion track hub 110, X, Y, Z data can be transmitted to server engine 150 so as to enable formation of a virtual 3-dimensional object. The virtual 3-dimensional object can have its own X, Y, Z data and can represent user's perspective and/or motion tracked object in the virtual world. When user and/or motion tracked object moves, their movement can be tracked and reflected in the virtual world accordingly. In an aspect, physically, axis X and axis Y can represent 2D horizontal position, and axis Z can represent vertical position in motion tracking area.

In an aspect, motion track sensor of the present disclosure include an optical motion track sensor, and/or can also work with any other suitable motion tracking technology, including but not limited to, 3 DOF (degrees of freedom), 6 DOF, 9 DOF, infrared, OpenNI, while the virtual X, Y, Z positions remain.

In another aspect, virtual presence of tracked perspective and/or objects can generally be, but not limited to, usage of navigation, interaction with simulated environment with human body and/or physical object and/or tools. Navigation with body movement and/or change of viewing point within motion tracking area can usually be for navigation in smaller virtual environment, e.g. a room, while grabbling navigation with a wireless controller can be more suitable for larger scale navigation, e.g., a district. The wireless controller can also be used for giving commands to control simulated environment, wherein when the motion tracked virtual object appears in virtual world, it is a concrete presence in simulated environment and can interact with simulation including but not limited to objects, surroundings or AI characters.

In an aspect, the proposed system enables output of 3D simulated visuals on multi-side displays in accordance with tracked position and perspective during navigation and cyber-physical interaction. Virtually user is in an infinite 3-dimensional simulated space, whereas physically, the user is in a room in cube shape. In an exemplary implementation, perspective calculation in the present disclosure can allow up to 6-side of seamless displays to form a full aspect of simulated environment when all sides of displays are perpendicular to each other. Instant display on each side can be calculated based on ever changing X, Y, Z of view point to that side, and therefore all sides of visuals can be calculated, blended and wrapped at the same time, based on which full-aspect of simulated environment can be formed physically. With this technology, presence of displays is not critical and calculation is independent. As would be appreciated, minimum of 1-side display is required to show the instant simulated environment, and any other form within between 2 to 6 sides of wrapped displays can be supported as along as the displays are physically in perpendicular angle to each other.

In an aspect, apart from the instant visual perspective and wrapping calculation, server engine 150 of the present disclosure can rapidly generate a pair of images to one or more projectors at a refreshing speed of, say 120 Hz, one for each of the user's eyes (at a refreshing speed of 60 Hz for each eye), based on the motion tracking data. Shutter 3D glasses can be synchronized with the one or more projectors so that each eye only sees the correct image.

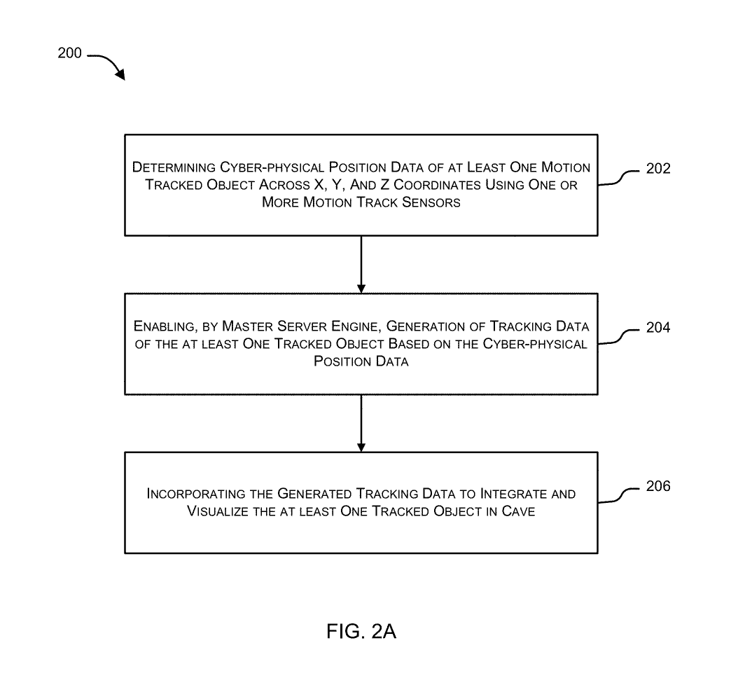

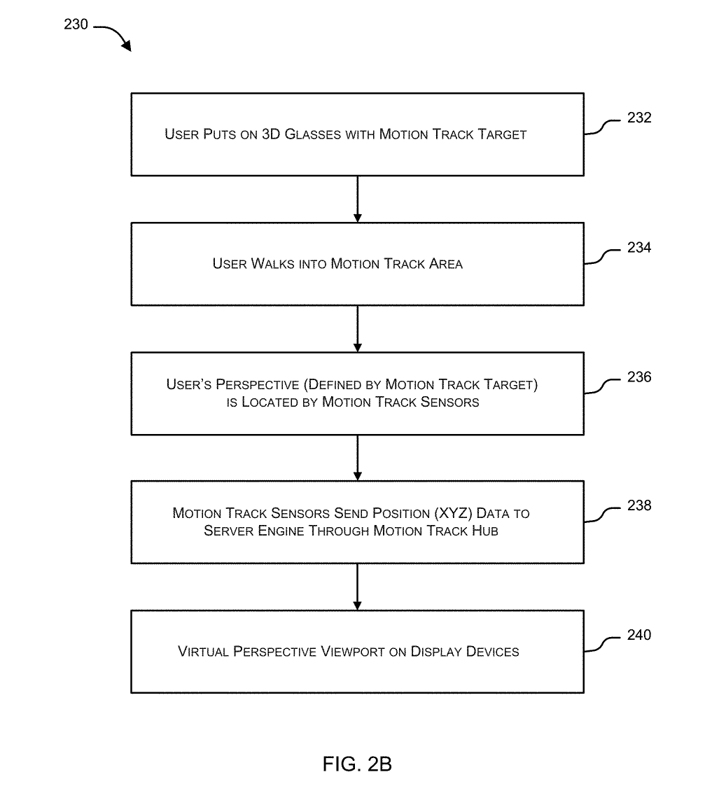

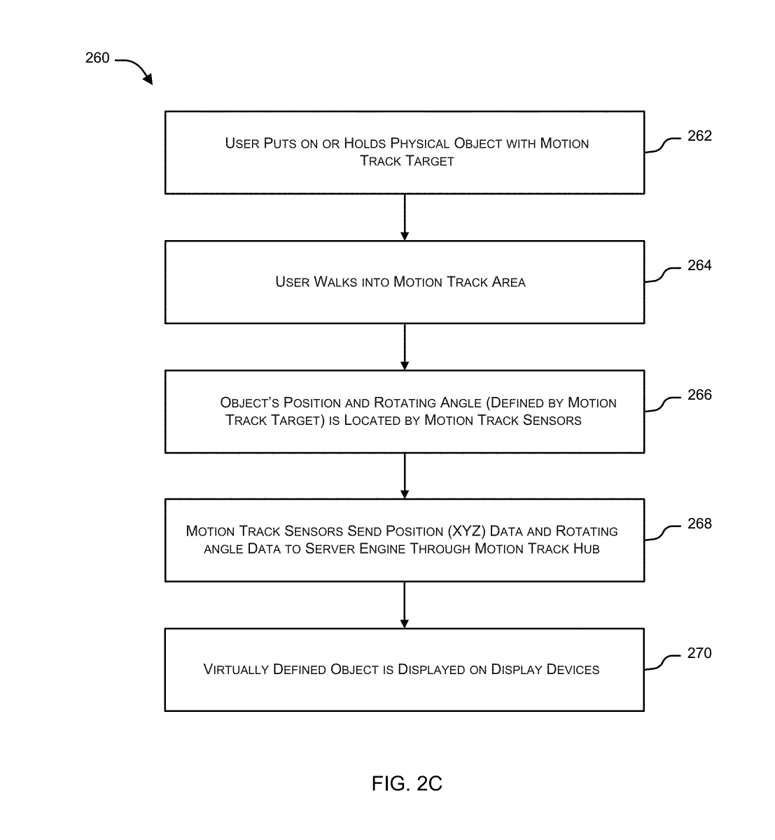

FIGS. 2A to 2C illustrate exemplary flow diagrams that show process of implementation of physical interaction with VR and MR simulated environment in accordance with embodiments of the present disclosure.

With reference to FIG. 2A, the proposed method can include, at step 202, determining, by a real-time motion tracking engine that is operatively coupled with a master server engine, cyber-physical position data of at least one motion tracked object across X, Y, and Z coordinates using one or more motion track sensors that are operatively coupled to the real-time motion tracking engine. At step 204, the proposed method can include the step of enabling, by the master server engine, generation of tracking data of the at least one tracked object based on the cyber-physical position data, and at step 206, the method can include the step of incorporating the tracking data to integrate and visualize the at least one tracked object in the CAVE, wherein the master server engine can be configured to enable multi-side electronic visual displays.

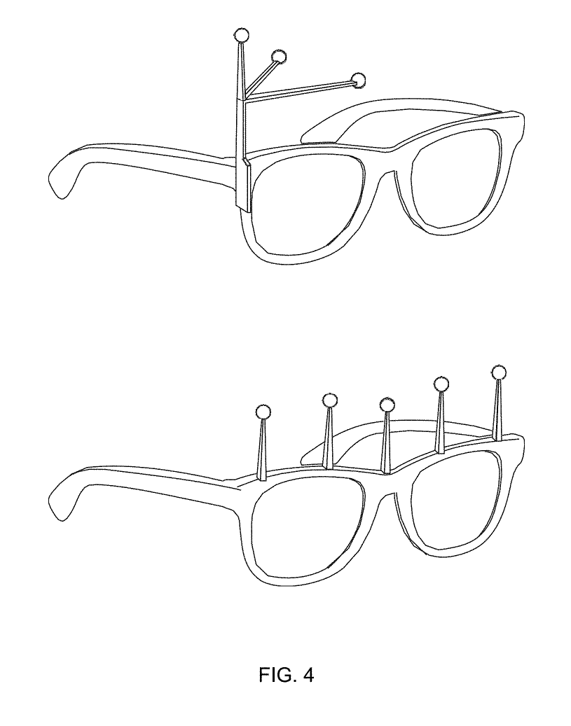

FIGS. 2B and 2C are exemplary non-limiting implementations of the proposed architecture, wherein with reference to FIG. 2B, at step 232, a user puts on his/her 3D glasses with a motion track target. As would be explained subsequently, motion track target can be a tangible object such as the one shown in FIG. 4, which can be worn on by the user to enable tracking of movement of the user based on XYZ coordinates of the motion track target as captured by one or more motion track sensors. After putting on the 3D glasses, the user, at step 234, moves into the motion track area, based on which, at step 236, using the motion track target, user's (or of the object with which the motion track target is coupled/associated) position and rotating angle can be determined through motion track sensors and given as output to motion track engine (106 of FIG. 1A). At step 238, the motion track sensors send the position data to server engine (150 of FIGS. 1A and 1B) through, for instance, a motion track hub, based on which, at step 240, the server engine processes the position data and generates a virtual perspective viewport to be projected onto one or more display devices.

With reference to FIG. 2C, at step 262, method of this embodiment involves a user to put on or hold a physical object that has a motion track target configured therein or coupled thereof, post which, at step 264, the user moves into the motion track area, based on which, at step 266, using the motion track target, user's (or of the object with which the motion track target is coupled/associated) position and rotating angle can be determined through one or more motion track sensors and given as output to motion track engine (106 of FIG. 1A). At step 268, the motion track sensors can send the position data to server engine (150 of FIGS. 1A and 1B) through, for instance, a motion track hub, based on which, at step 270, the server engine processes the position data and generates a virtual perspective viewport to be projected onto one or more display devices.

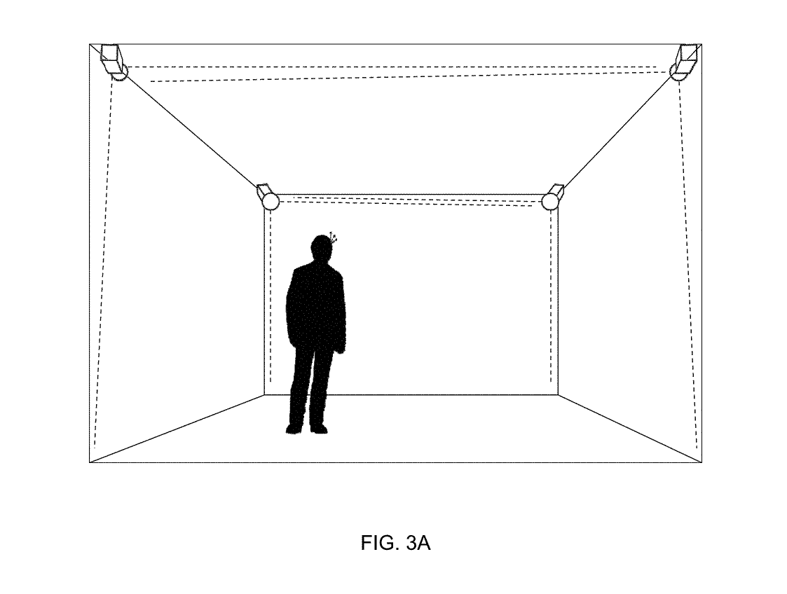

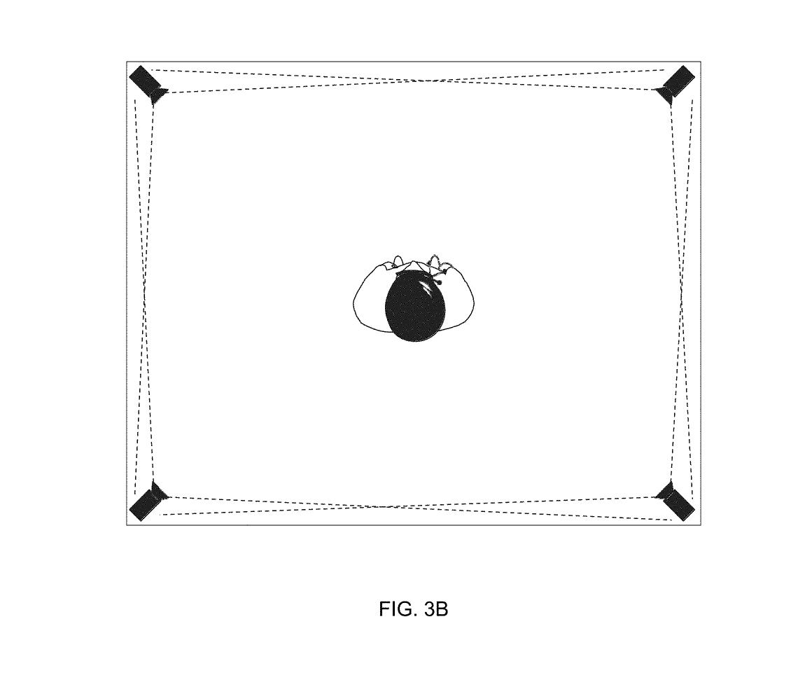

FIGS. 3A and 3B illustrate motion tracking area to be covered by motion track sensors in a 3D view and from a top perspective respective. In an aspect, motion tracking area can be a 3D environment, where the users' activities with motion track target should all be tracked and recorded. In an exemplary implementation, motion track sensors can be configured at four corners of the motion track area and also above the visual area so as to maximize sensing covered area but minimize blind spot. It would be appreciated that any other configuration, shape, size, dimension of motion tracking area can be configured as part of the present disclosure and such implementation is surely not limiting in any manner.

FIG. 4 illustrates examples of different combinations of motion track target on active 3D glasses for user's perspective tracking. In an exemplary implementation, each motion track target (also referred to article to be used for tracking movement) can include at least 3 motion track markers, wherein arrangement of each motion track target can be different from others in each application. Position of each marker can be captured by motion track sensors and corresponding X, Y, Z data (also referred to as position data) can be transmitted to server engine in order to form distinctive 3-dimensional virtual object definition.

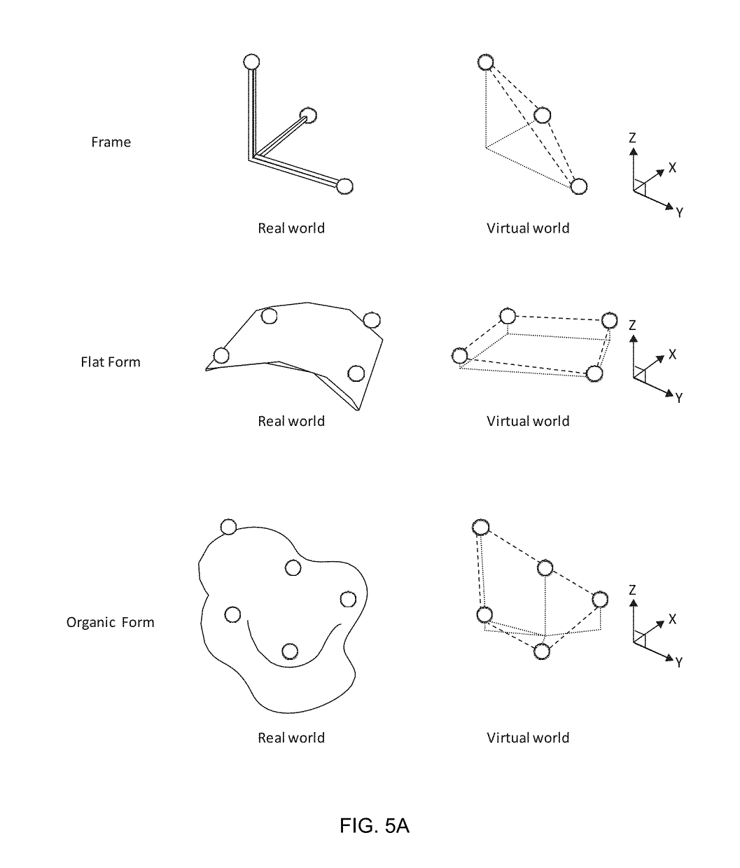

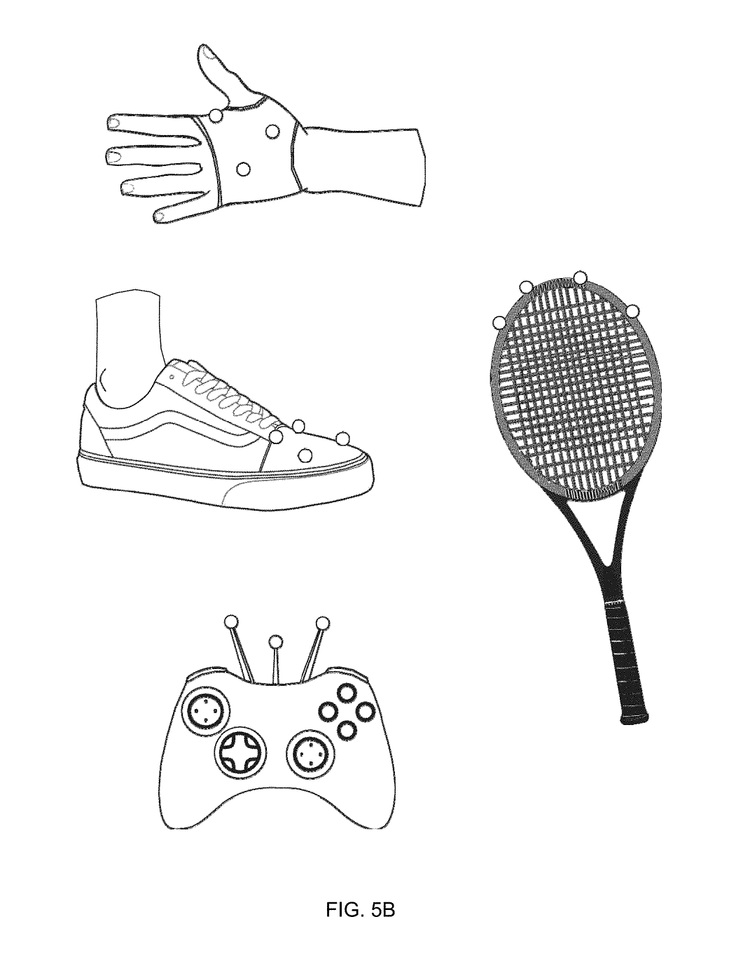

FIG. 5A shows examples of possible combinations of motion track target on different forms of physical objects, as well as corresponding presence forms in virtual world. In an exemplary implementation, combination of each motion track target can require at least 3 motion track markers. Examples herein with respect to FIG. 5 show combination of 3-5 motion track markers. In real world, the proposed motion track target can be attached on any form of physical object including, but not limited to, a frame, a flat form, an organic form, etc. In virtual world, a 3-marker target can include 3 groups of X, Y, Z coordinates from each marker, each group forming a distinctive 3-dimensional object with its own X, Y, Z data being transformed from physical space to virtual space. In such a way, any physical object can become a motion track target as shown in FIG. 5B. All such motion track targeted objects (such as users or articles to which the motion track targets are attached) can interact with virtual simulated environment as they are all recognized as distinctive 3-dimensional objects in virtual world.

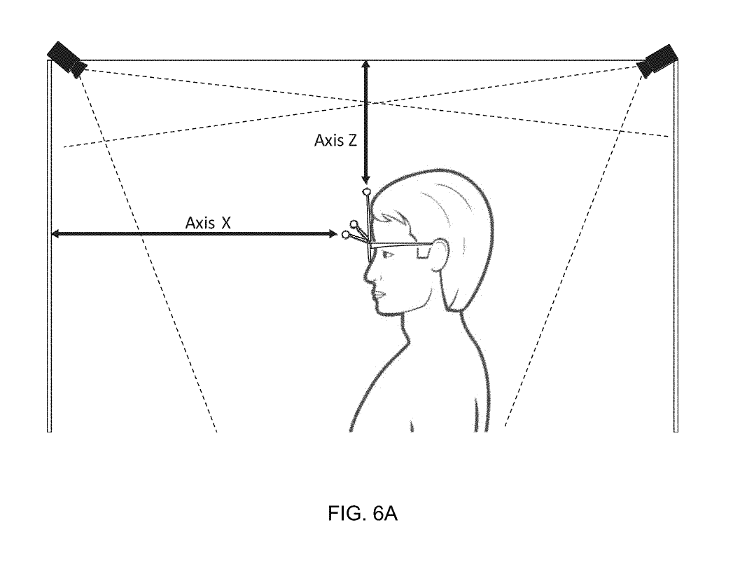

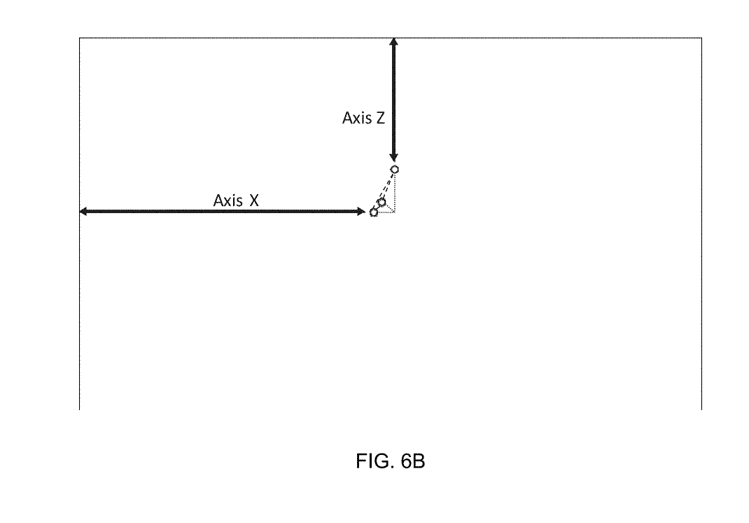

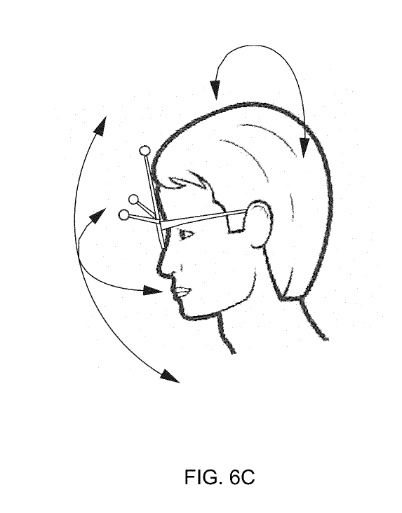

FIG. 6A illustrates an exemplary user's perspective being defined by a motion track target and being tracked within motion tracking area. User's perspective can be represented by a 3-marker motion track target. As illustrated in FIGS. 5A and 5B, a distinctive 3-dimensional object can be formed with its own X, Y, Z data. Physically, axis X and axis Y represent 2D horizontal position, and axis Z represents vertical position in motion tracking area. When user moves, X, Y, Z physical data of the object changes, and such physical data is synchronously processed in the server engine in order to calculate virtual position (relevant viewpoint in this example) as shown in FIG. 6B, which illustrates calculated viewpoint of motion tracked target perspective in virtual world.

In FIG. 6C, turning of head is physically natural; however this natural movement should not turn the simulated environment around or upside down, and therefore, in an exemplary implementation, when server engine receives perspective data, virtual rotation is not applied, so that when the users' head is down or when the user looks up, flooring and ceiling environment remains on bottom and on top respectively, which enables a lifelike environment that echoes with human being's experience.

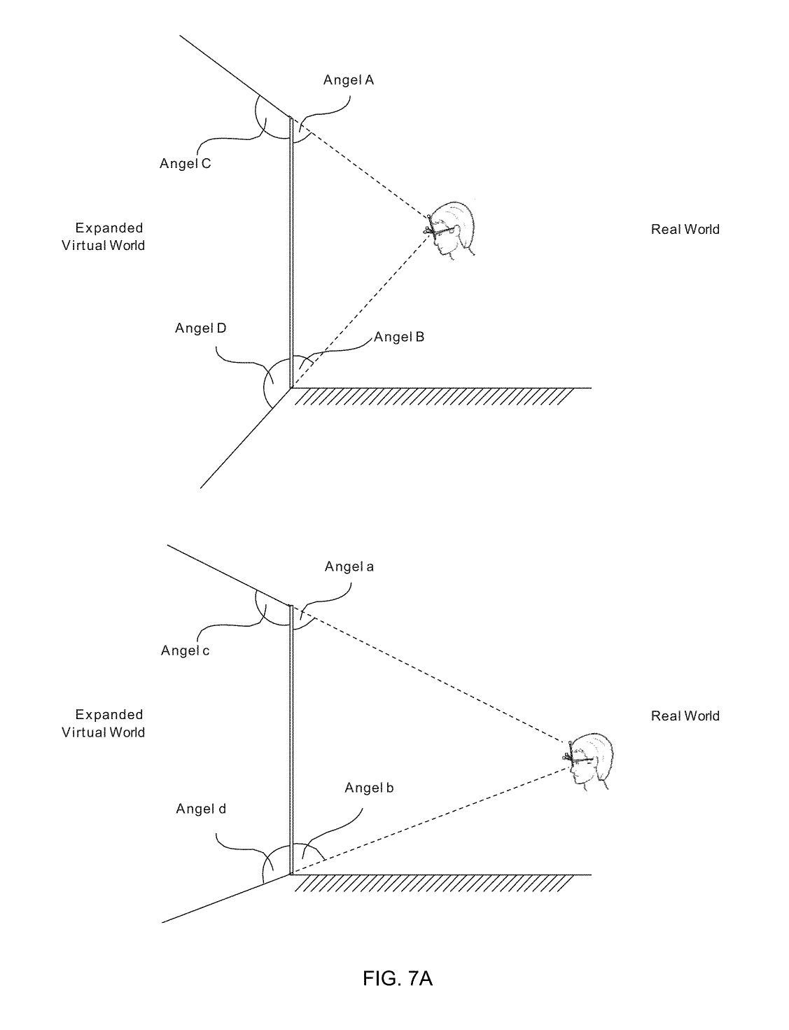

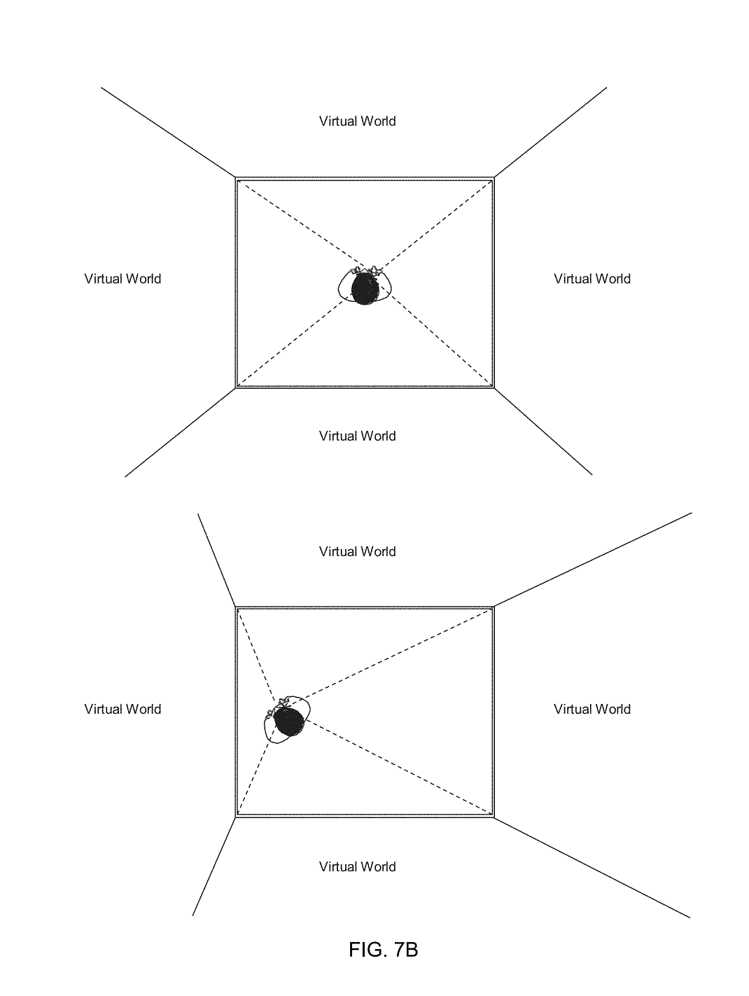

FIGS. 7A and 7B illustrate correlation of perspective angles in real world and virtual world from side view and top view respectively. In an exemplary implementation, relationship of physical world and expanded virtual world can be in 1:1 scale, meaning that the 3-dimensional areas in both the worlds can be same size, scale and level. When user's perspective (defined motion track target) position is tracked in motion track area, there is a triangular relation formed between motion track target position and each side of calculated visual area. Viewing angles in physical world and virtual world can be correlated as viewing frustum. Taking one side of display for example, there can be angles A, B, C and D, wherein angles A and B can be physical angles formed by motion track target to be in physical display, and angles C and D represent expanded viewing angles to be in virtual world. A truncated pyramid can be expanded unlimitedly in the virtual world. User can thus see an infinitely expanded virtual world in the visual simulated environment. Expanded virtual angle can depend on physical viewing angle and position, as angle A+angle C and angle B+angle D must be equivalent to 180 degrees. Movement of user may lead to physical angles A and B, based on which angles C and D change simultaneously in the virtual environment. As shown in FIG. 7B, for example, in a 3-dimensional environment formed by 4-side of perpendicular visual displays, 4 viewing frustum correlations can be formed, and 4-side of expanded, infinite virtual simulated environment can be calculated and displayed. A 360 degrees full aspect can be formed with the 4-moving frustum. It would be appreciated that theoretically, there are 6-moving frustum if physical display exists.

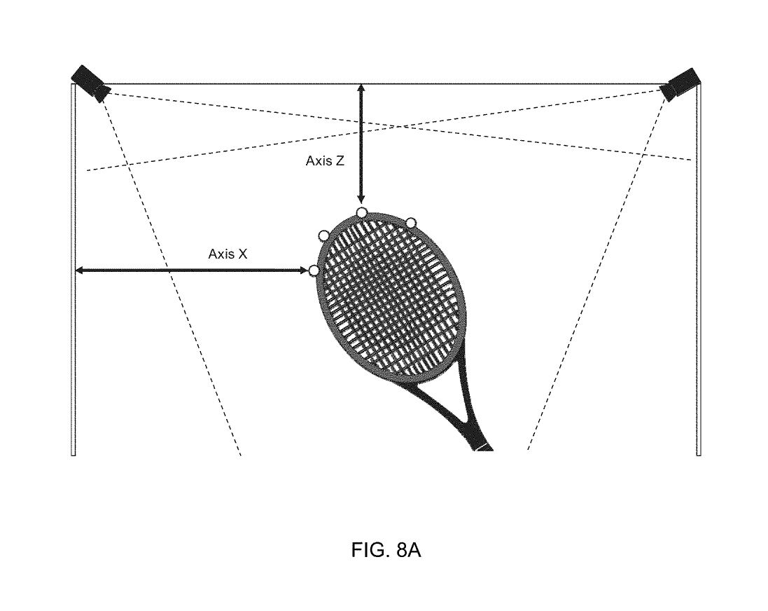

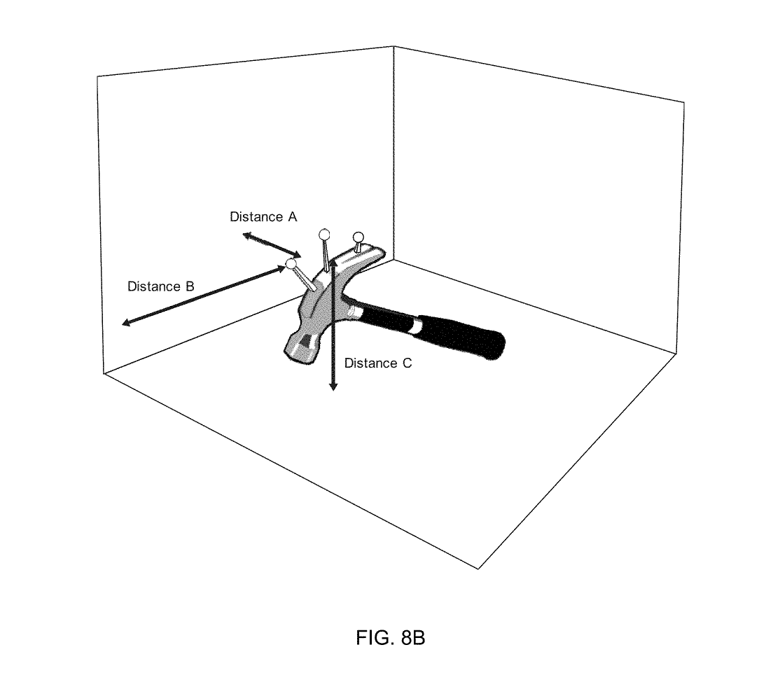

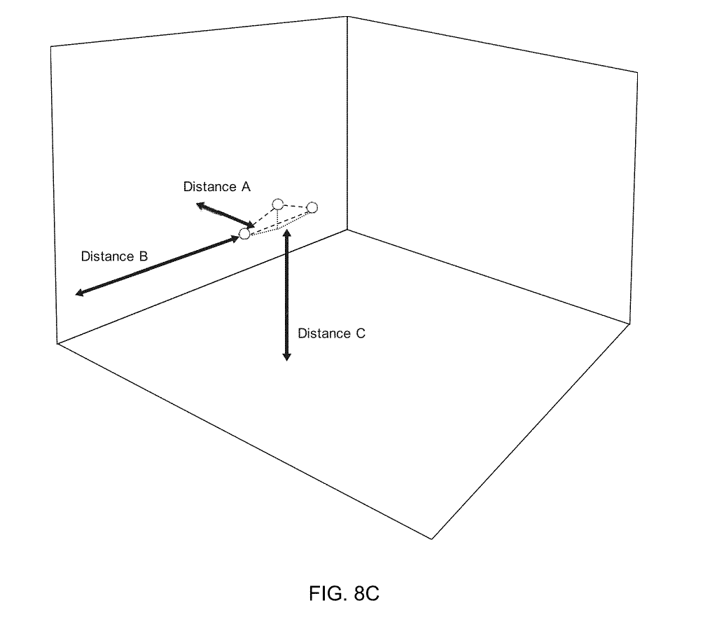

FIG. 8A illustrates an exemplary physical object that can be defined by motion track target and can be tracked within the motion tracking area. A distinctive 3D object can be formed with its own X, Y, Z data. Physically, axis X and axis Y represent 2D horizontal position, and axis Z represents vertical position in motion tracking area. FIG. 8B, on the other hand, illustrates motion tracked physical object presence, where when the object moves physically; X, Y, Z data of the object changes and it is synchronously processed in the server engine. Calculated corresponding object position in virtual world can be seen in FIG. 8C.

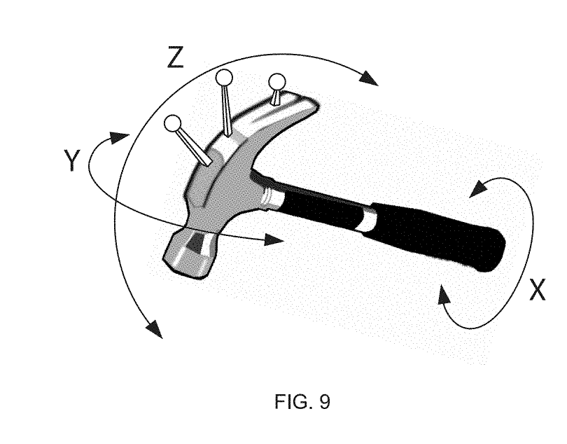

FIG. 9 illustrates additional rotation data processing of a physical object that is associated with 3 motion track markers. In implementation, when X, Y and Z data is captured by motion track sensors and transmitted to server engine through motion track hub, the embodied programme enables rotation of the physical objects. This is due to user's eyes acting as a floating camera when viewed and interacted with an augmented object in virtual world, while physical object is an orbit presence. Rotation data can be captured and calculated by server engine to synchronise physical and virtual movement of the physical object.

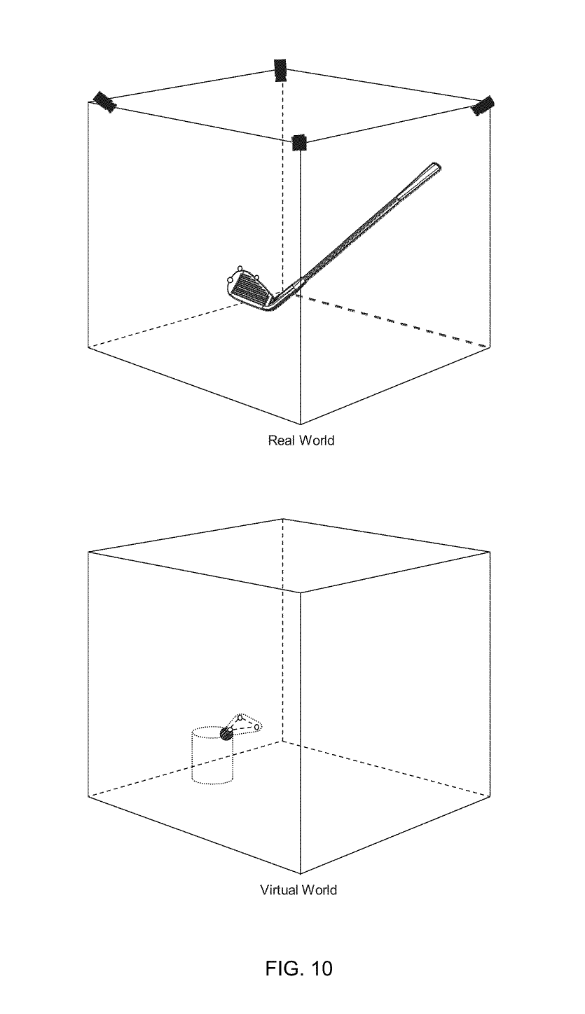

FIG. 10 illustrates interaction of motion tracked physical object and simulated environment in augmented reality. Virtual position of the tracked object can be defined by the X, Y, and Z of its motion track target. Relevant data can be transmitted to the server engine, and virtual presence can be created by the input data. With its virtual existence in the simulated environment, any movement controlled by user physically can be reflected in simulated scene simultaneously. As the virtual object and simulated environment exist in the same virtual world, when the virtual object interacts with other existence in virtual scene, response and reaction can be triggered and server engine can output corresponding visual of the integration.

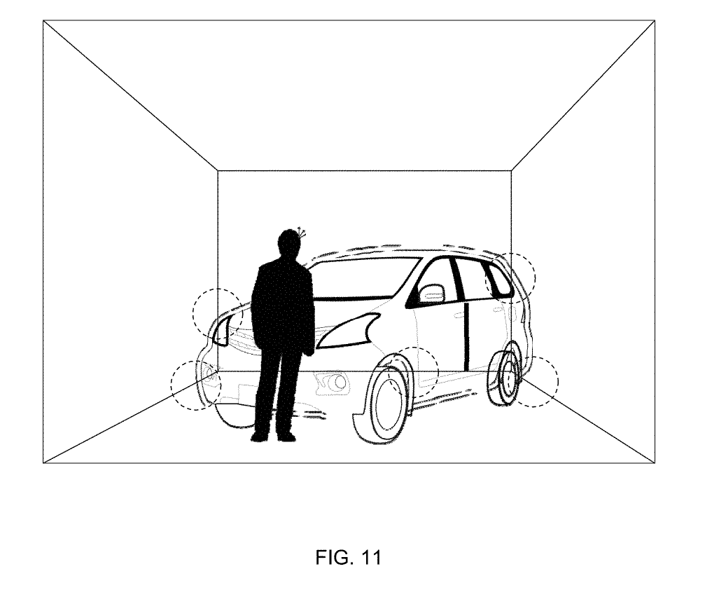

FIG. 11 illustrates real-time calculated perspective of a physical object in full aspect. In an implementation, perspective and edge blending calculation can be embodied in the server engine so as to enable seamless visual output processing. Simulated environment can be, as a whole, virtual, however, a seamless visual of simulated environment can be physically presented by multi-side display devices, through one or more stereo projectors. Server engine can process position, interaction, and visual data, viewing angle data, and instantly output refreshing speed images through graphical processors without any sub-server. The graphical processors distribute 6-side of correct images, and allocate such images to each side connected projectors so as to ensure that all images on multi-side displays are blended and wrapped together so as to form a seamless simulated environment.

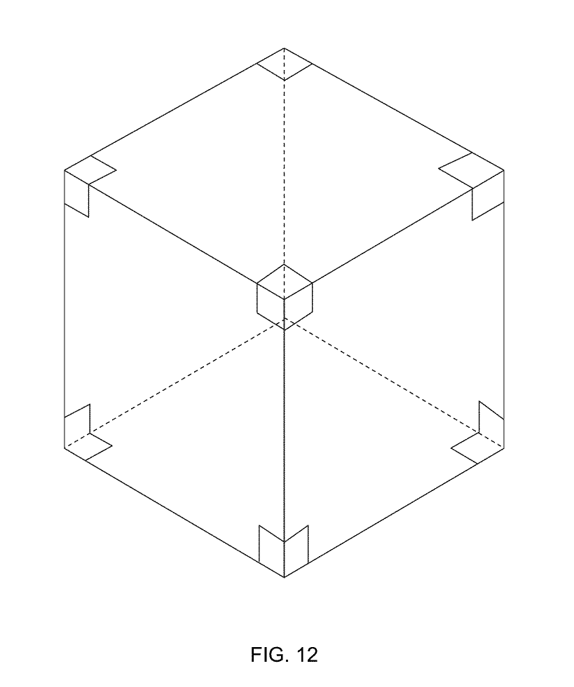

FIG. 12 illustrates calculation of perpendicular display format of the proposed technology, wherein computing architecture of the present invention can be formulated to present a full aspect environment with maximum 6-side of displays. Therefore, the embodied programme defines motion track target position and visualises simulated environment based on a cube shaped environment with 6-sides. Similarly, after server engine has processed position and visual data along with virtual interaction and viewing angle data, it outputs up to 6-side of pairing images (i.e., 12 images at once) on perpendicular multi-side displays that are blended and wrapped together to form a seamless simulated environment.

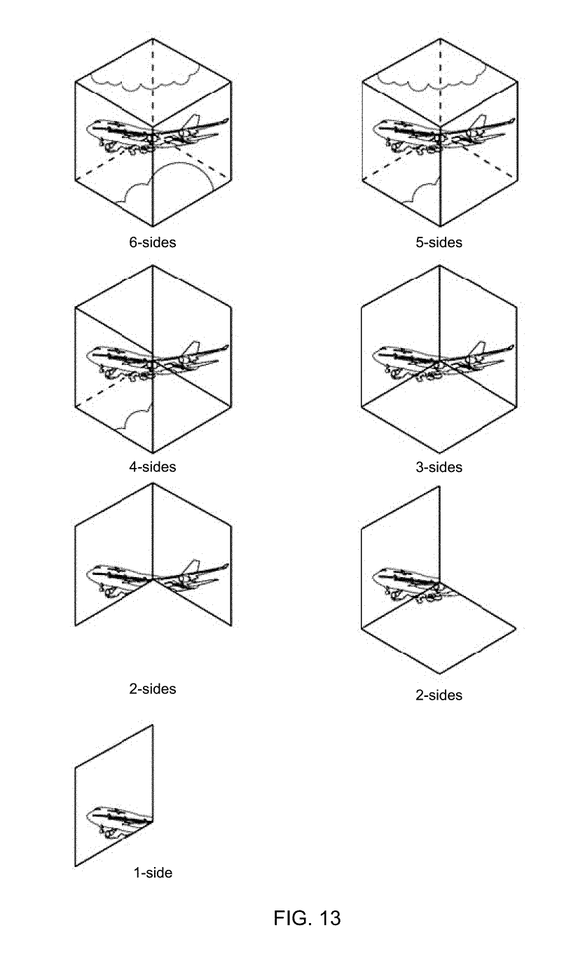

It would be appreciated that although the programme embodied system can process up to 6-side calculation of immersive environment, it is not easy to have a 6-side set-up due to physical limitations. FIG. 13 illustrates presentations of full aspect simulated environment in perpendicular display format. Functionality of the embodied calculation and output can remain under all circumstances of 1-side, 2-side, 3-side, 4-side, 5-side and 6-side displays. Number of sides of visualization of simulated environment can be related to the number of electronic connections between server engine and projector(s) (display device), wherein no sub-server is required to allocate jobs or to drive display device.

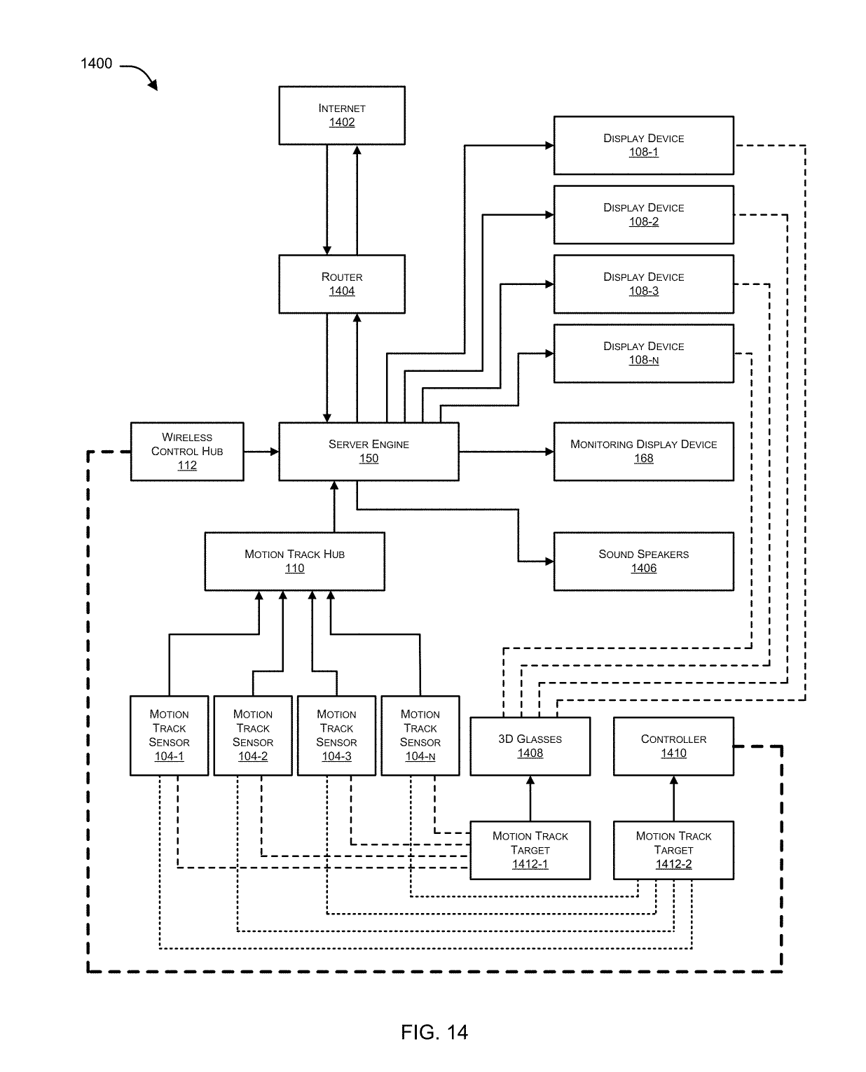

FIG. 14 illustrates a representation of hardware configuration and their connections of embodiments of the subject technology. An example of the proposed embodiment provides a 4-side immersive CAVE, including a server engine 150 that is embodied with programme for position, interaction, perspective calculation and real-time rendering, stereo output distribution; a plurality of motion track sensors 104, wherein the plurality of motion track sensors 104 can be configured to detect infrared light from motion track target 1412 to communicate position and motion data to the server engine 150 through connection of motion track hub 110; a controller 1410 that can be configured to input command to the server engine 150 through a wireless control hub 112 with connection to the server engine 150; display devices 108 and sound speakers 1406 to support visual and audio output; a router 1404 to cloud access for offsite monitoring and update through Internet 1402; a monitoring display device 168 for onsite operation and maintenance. In an aspect, the immersive CAVE system can execute real-time interactive simulated environment with the proposed server engine.

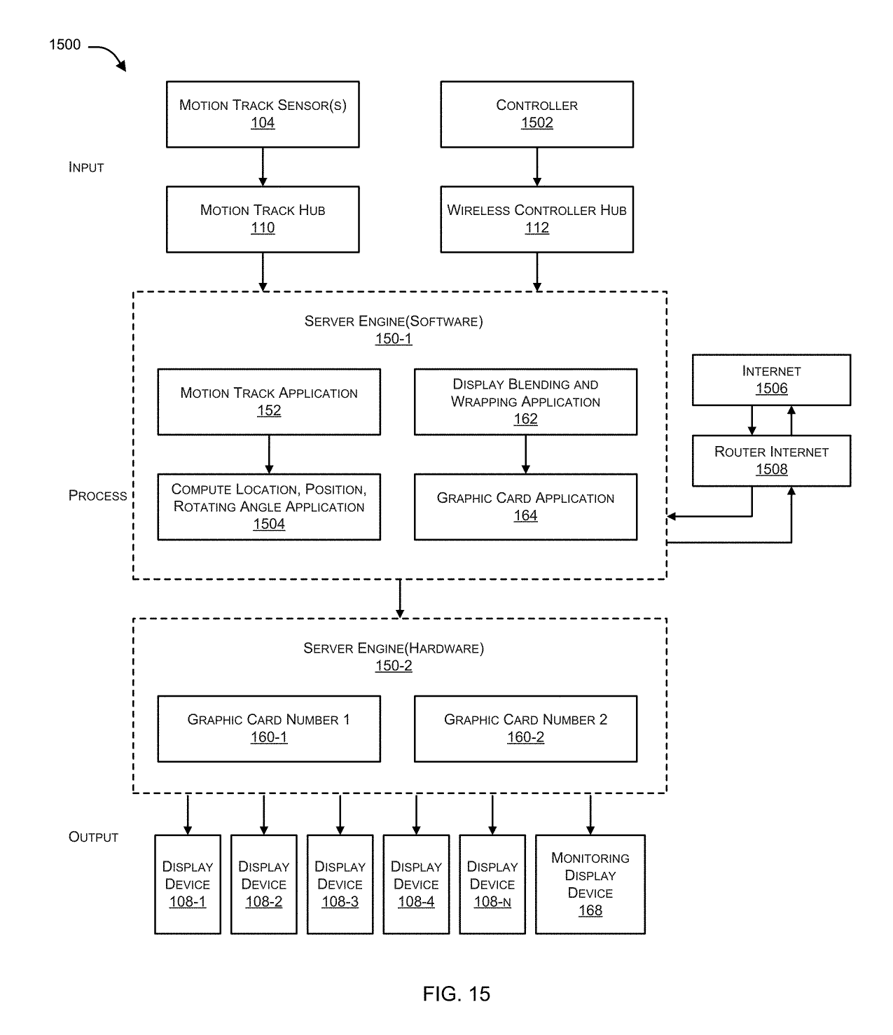

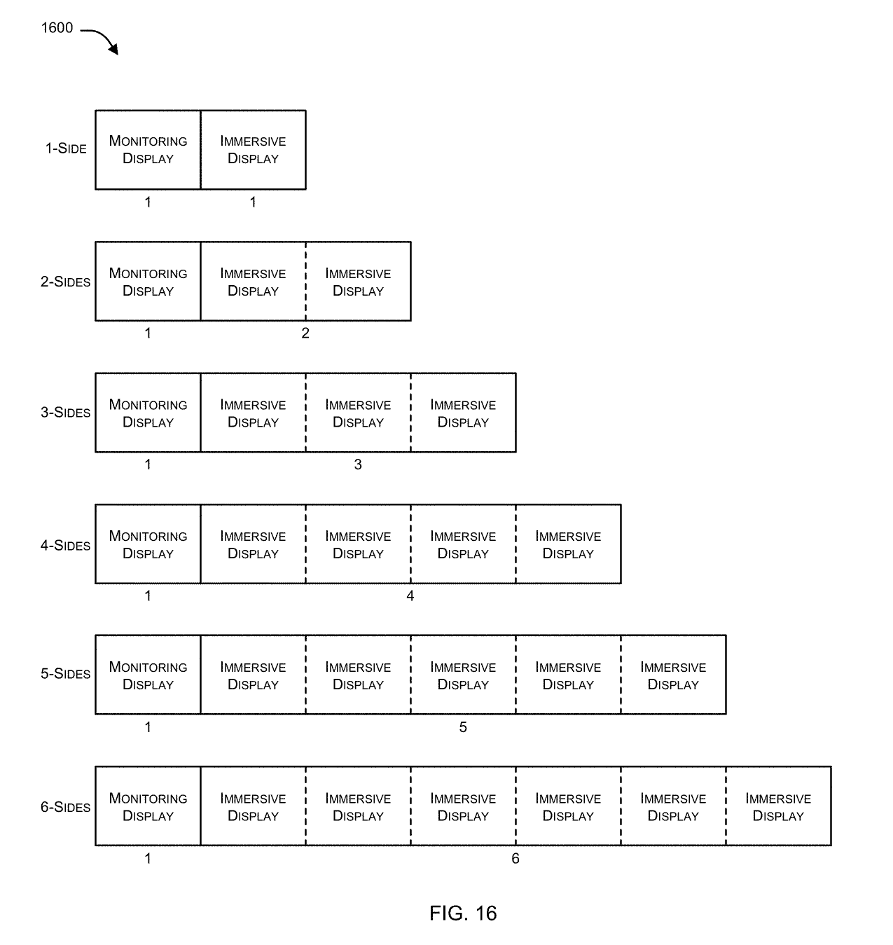

FIG. 15 illustrates input and output processing of server engine 150. Motion track sensors 104 and wireless controller 1502 input data of location, position, rotating angle and command to the server engine 150 through motion track hub 110 and wireless control hub 112 respectively. The software embodied server engine 150 can firstly recognise motion tracked target to decide if it is user's perspective or other objects, and then compute target location, position, rotating angle, perspective and interaction data. After data of simulated environment is calculated and virtual environment is generated, a display blending and wrapping application can distribute 6-side of visuals that blends together to form a full aspect view; based on which a visual distribution command can be given to graphic cards 160 through a graphics card application. The graphic cards can push visual data to assigned display devices 108 to output images at a refreshing speed, for instance at 120 Hz, and operational activities on monitoring display device as shown in FIG. 16.

It would be appreciated from the above disclosure that the present invention enables real-time motion tracking, physical & virtual positions & perspective calculation and real-time 3D immersive visualization functionalities. The proposed system immediately (without noticeable delay) reacts to users' perspective and physical commands. Also, physical objects can be integrated into the virtual environment. Any changes, movement in physical world can be detected by motion tracking system, and visually reflected by real-time immersive visualization. In another aspect, system of the present disclosure enables real-time motion tracking by MF's integration with motion tracking system. The proposed motion tracking system can define XYZ positions of tracked object(s) and tracked perspective, wherein such position data is interpreted by the server engine, and assigned relating virtual objects and corresponding simulated environment based on interpreted data (also referred to as tracked data). In an implementation, visualized tracked data can be integrated into corresponding environment in immersive CAVE without noticeable delay, enabling real-time immersive visualisation. Using the proposed system, real-time calculations of transmitting data to 3D visualization can be done, along with using a real-time rendering engine to output up to 6-sides of 3D visual data, at a speed of, for instance, 60 Hz each eye (making it generation speed at 120 Hz/second). Once all real-time motion tracking, transmission, rendering, visualization and output are stable, users can interact with the immersive CAVE simultaneously. VR and MR simulation can also be supported.

As used herein, and unless the context dictates otherwise, the term “coupled to” is intended to include both direct coupling; in which two elements that are coupled to each other contact each other, and indirect coupling; in which at least one additional element is located between the two elements. Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

We claim:

1. A system for implementing an immersive Cave Automatic Virtual Environment (CAVE), said system comprising:
a master server engine configured to enable multi-side electronic visual displays;
a real-time motion tracking engine that, using said master server engine, in real-time:
determines cyber-physical position data of at least one motion tracked object across X, Y, and Z coordinates using one or more motion track sensors that are operatively coupled to said real-time motion tracking engine; and
enables generation of tracking data of said at least one tracked object based on said cyber-physical position data, said tracking data being used to, by said master server engine, integrate and visualize said at least one tracked object in said CAVE.

2. The system of claim 1, said system comprising an import module that enables a user to import digital visual content into said master server engine for real-time immersive content visualization.

3. The system of claim 2, wherein said digital visual content is created by any or a combination of a 3-dimensional (3D) application, a 2-dimensional (2D) application, or a visual recording/scanning technology.

4. The system of claim 1, wherein said master server engine performs real-time computation of 360 full aspect perspective.

5. The system of claim 1, wherein said multi-side electronic visual displays range from 1 to 6 side displays.

6. The system of claim 1, wherein said at least one motion tracked object is a user of said system.

7. The system of claim 1, wherein said at least one tracked object is projected onto a tangible medium.

8. The system of claim 1, wherein said at least one tracked object is visualized in any or a combination of a cube-shaped environment, an immersive VR environment, a head-mounted display enabled environment, desktop computer enabled environment, display screen enabled environment.

9. The system of claim 1, wherein said at least one motion tracked object is attached to a user such that when said user is in a motion tracking area, said motion tracking engine, using said one or more motion track sensors, detects viewpoint and position of said at least one motion tracked object so as to generate said cyber-physical position data.

10. The system of claim 1, wherein said at least one motion tracked object is operatively coupled with or comprises at least 3 motion track markers such that position of each motion track marker is defined by its X-axis, Y-axis, and Z-axis, wherein X-axis represents horizontal position in relation to front of motion tracking area, wherein Y-axis represents horizontal position in relation to left and right side of said motion tracking area, and wherein Z-axis vertical position in relation to top side of said motion tracking area.

11. The system of claim 1, wherein said one or more motion track sensors are selected from any or a combination of optical motion track sensors, and sensors configured to enable motion tracking across 3 degrees of freedom (DOF), 6 DOF, 9 DOF, infrared, OpenNI.

12. The system of claim 1, wherein said one or more motion track sensors detect infrared light to communicate position and rotation data of said at least one tracked object to said master server engine.

13. The system of claim 1, wherein said at least one tracked object is controlled for any or a combination of navigation, change in viewing point, and interaction with other visualized objects through a controller.

14. The system of claim 1, wherein said at least one tracked object is visualized in a 6-side simulated environment by receiving, at one or more projectors, said tracking data from said master server engine, and blending and wrapping said received tracking data to generate a full aspect view of said at least one motion tracked object in said simulated environment.

15. The system of claim 1, wherein said tracking data comprising virtual positions and angles of said at least one tracked object.

16. A method for implementing an immersive Cave Automatic Virtual Environment (CAVE), said method comprising the steps of:
determining, by real-time motion tracking engine that is operatively coupled with a master server engine, cyber-physical position data of at least one motion tracked object across X, Y, and Z coordinates using one or more motion track sensors that are operatively coupled to said real-time motion tracking engine; and
enabling, by said master server engine, generation of tracking data of said at least one tracked object based on said cyber-physical position data, said tracking data being used to integrate and visualize said at least one tracked object in said CAVE, wherein said master server engine is configured to enable multi-side electronic visual displays.

17. The method of claim 16, wherein said multi-side electronic visual displays range from 1 to 6 side displays.

18. The method of claim 16, wherein said at least one motion tracked object is operatively coupled with or comprises at least 3 motion track markers such that position of each motion track marker is defined by its X-axis, Y-axis, and Z-axis, wherein X-axis represents horizontal position in relation to front and back of motion tracking area, wherein Y-axis represents horizontal position in relation to left and right side of said motion tracking area, and wherein Z-axis vertical position in relation to top side of said motion tracking area.

19. The method of claim 16, wherein said at least one tracked object is controlled for any or a combination of navigation, change in viewing point, and interaction with other visualized objects through a controller.

20. The method of claim 16, wherein said tracking data comprising virtual positions and angles of said at least one tracked object.
